(19) United States
(12) Patent Application Publication
(10) Pub. No.: US 2007/0220990 A1
(43) Pub. Date: Sep. 27, 2007

(54) Material testing apparatus with selectively sealed and unsealed dies

(76) Inventors: John B. Putman, Cuyahoga Falls, OH (US); Matthew C. Putman, Brooklyn, NY (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/388,886

(22) Filed: Mar. 23, 2006

(51) Int. Cl. G01N 3/08

(52) U.S. Cl. 73/818

(57) ABSTRACT

Improvements to a sealed die material testing apparatus having dies with associated seal plates include providing apparatus modifications that enable the apparatus to be employed as a non-sealed die system. Improvements include adapting the seal plates to carry spacers and, alternatively, adapting the apparatus to effect a gap between the seal plates.

### TECHNICAL FIELD

The present invention generally relates to apparatus for the testing of physical properties of materials in which the sample of material to be tested is held in a test position between two dies. More particularly, this invention relates to such an apparatus employing dies having seal plates but yet being selectively sealed or unsealed in use, according to user preference.

### BACKGROUND OF THE INVENTION

Instruments to measure the flow and vulcanization characteristics of materials have been in use in substantially the same manner since the 1960's. These instruments generally hold a sample of material (e.g. rubber) between two dies and measure the torque required either to oscillate or rotate the dies against the sample or to oscillate or rotate a rotor that is sandwiched within the sample. The dies, as they close upon the sample, may form either a sealed or unsealed cavity. More recently, these instruments have been adapted to measure the pressure developing within the die cavity. U.S. Pat. Nos. 3,182,494; 4,953,406; 4,343,190; 4,953,406; and 5,079,956 describe apparatus that use sealed cavities for viscoelastic and vulcanization measurements. U.S. Pat. No. 3,688,568 describes an apparatus that forms a cavity that is held under pressure but not sealed. The Monsanto Cone Rheometer is an example of a rheometer adapted to measure vulcanization characteristics as well as pressure characteristics.

Two basic cavity systems are employed in the prior art, sealed cavities and unsealed cavities. FIG. 1A illustrates a typical sealed cavity and FIG. 1B a typical unsealed system. Although both systems are used primarily to measure viscoelastic and vulcanization characteristics of a material, they can also be instrumented to measure cavity pressure.

The sealed cavity in FIG. 1A consists of lower platen 1, to which lower seal plate 2 is attached. Plastic or elastomeric seal 3 is affixed to lower seal plate 2. Upper seal plate 6 is attached to upper platen 5. Upper seal plate 6 holds upper seal 7. When upper and lower seal plates 6 and 2 are biased together, they form a fully sealed cavity with boundaries defined by lower seal plate 2, lower seal 3, lower die 4, upper seal plate 6, upper seal 7 and upper die 8. Specimen 9 is fully contained in these boundaries, although, as the dies 4 and 8 close upon the sample, excess material 10 is extruded out of the sealed cavity. Seal plates 2 and 6 contact at point 11, thus sealing in even the extruded excess of the sample.

The unsealed cavity in FIG. 1B consists of lower platen 12, lower die 13, upper platen 16 and upper die 17. When biased together, upper and lower dies 17 and 13 do not contact, nor do platens 12 and 16, thus establishing a gap at area 14. Thus, the cavity formed is fully unsealed and sample 18 and extruded excess 15 are not contained in a sealed cavity. Notably, as the lower die is oscillated or rotated, the extruded excess 15 is subjected to such oscillation or rotation. This is distinguishable from the sealed die system, in which the extruded excess is held between seal plates that do not move, and thus is not subjected to oscillation or rotation.

A prior art apparatus using a sealed cavity is shown in FIGS. 2A and B. In the open position of FIG. 2A, upper platen 5 is attached to drive shaft 22 to move the platen assembly. Typically, this mechanism is a pneumatic cylinder but may be a hydraulic device or motor. Upper die 8 is attached to torque and pressure transducer 26, which, in turn, is attached to upper platen 5. Support rods 23 and 24 provide support for the drive mechanism mounted on upper support plate 20. Lower die 4 is attached to mounting plate 25, which, in turn, is attached to an oscillating or rotating drive motor through drive shaft 21. Lower platen 1 is attached to lower support plate 19.

FIG. 2B shows the assembly in the closed position. Upper seal plate 6 and lower seal plate 2 contact at point 11, thereby forming the sealed cavity. Means (not shown) are generally provided for heating upper die 8 and lower die 4.

For an unsealed die system, the device of FIGS. 2A and 2B is substantially similar but for the fact that seal plates are not employed and, when the upper platen is moved fully downwardly toward the lower platen to sandwich the sample between the upper and lower dies, gaps exist between the dies and the platens. This gap is effected by contact between surfaces on an upper platen stop and threaded stops extending upwardly from the base of the apparatus. The extent to which the threaded stops extend above the base can be adjusted, through the stop threads, to establish different gap distances.

Cellular products that are produced by the expansion of a gas within a material (typically rubber material) are generally processed in two distinctly different manners. In a first method, the material is placed in a sealed mold and heated. The initial volume of the material is less than the volume of the mold, but, upon the release of the gases within the material, the material expands to fill the volume of the mold. In the second method, the material is shaped, as in an extrusion process, and heated without confinement in a mold. This heating may be in open hot air, by microwave, or in a liquid media such as a molten salt. In these instances, the gases cause the material to expand to its fullest extent, without confinement in a sealed mold. The resulting product in both processes is of lower density than the original material.

These cellular materials are tested in the above-referenced material testing apparatus, as are typical non-cellular materials. For the cellular materials, the pressure developing within the die is an important property to measure inasmuch as it helps quantify and qualify the expansion. Because the cellular materials expand during the testing, in much the same way that they expand during the production methods disclosed above, it would be advantageous to be capable of testing a material in the manner representative of either of these production methods. Thus, the present invention provides a testing apparatus that allows testing in a sealed or unsealed manner on the same instrument, with only minor alterations.

### SUMMARY OF THE INVENTION

The present invention provides improvements to sealed die material testing apparatus that include a first die associated with a first seal plate and a second die associated with a second seal plate, the first and second seal plates being in registration with each other and capable of movement toward and away from one another. The improvement comprises a drive mechanism that is selectively activated to move the first seal plate toward or away from the second seal plate; and means for stopping movement of the first seal plate toward the second seal plate such that a gap of from 0.2 to 2.0 mm exists between the first and second seal plates.

In accordance with various embodiments contemplated and taught herein, the means for stopping movement may be selected from spacers secured to one of said first or second seal plate and appropriate drivers for the first seal plate. A preselected distance driver that advances the first seal plate a chosen distance to effect a chosen gap is particularly preferred.

In a particular embodiment, a material testing apparatus includes a first platen associated with a first die and supporting a first seal plate and a second platen associated with a second die and supporting a second seal plate in registration with the first seal plate. The first platen, the first die and the first seal plate may be selectively advanced, as a unit, toward the second platen, the second die and the second seal plate. A spacer is secured to one of the first and second seal plates such that, when the first seal plate is selectively advanced toward the second seal plate, the spacer contacts between the first and second seal plates to prevent direct contact between the first and second seal plates.

### BRIEF DESCRIPTION OF THE DRAWINGS

FIG. 1A is a side view, in cross section, of a prior art sealed die system in a material testing apparatus;

FIG. 1B is a side view, in cross section, of a prior art unsealed die system in a material testing apparatus;

FIG. 2A is a side view of a prior art material testing apparatus employing sealed dies, shown in the open position;

FIG. 2B is a side view of a prior art material testing apparatus employing sealed dies, shown in the closed position;

FIG. 3 is a side view, in cross section, of a prior art sealed die system, shown modified in accordance with the present invention to be an unsealed system;

FIG. 4A is a top plan view of a seal plate in accordance with this invention, shown without the spacers that are provided in accordance with this invention;

FIG. 4B is a top plan view of the seal plate of FIG. 4A, shown with spacers mounted thereto;

FIG. 4C is a side view, in cross section, of a sealed die system, in the closed position, modified with the seal plate of FIG. 4B to be an unsealed system;

FIG. 5A is a side view, in partial cross section, of a material testing apparatus in accordance with this invention, employing a sealed die system, but modified in accordance with this invention to establish unsealed dies, in use, the apparatus being shown in an open position; FIG. 5B is a side view, in partial cross section, of a material testing apparatus as in FIG. 5A, but shown in a closed position;

FIG. 6A is a side view, in partial cross section, of a material testing apparatus in accordance with another embodiment of this invention, employing a sealed die system modified to establish unsealed dies, in use, the apparatus being shown in an open position; and

FIG. 6B is a side view, in partial cross section, of a material testing apparatus as in FIG. 6A, but shown in a closed position.

### PREFERRED EMBODIMENT FOR CARRYING OUT THE INVENTION

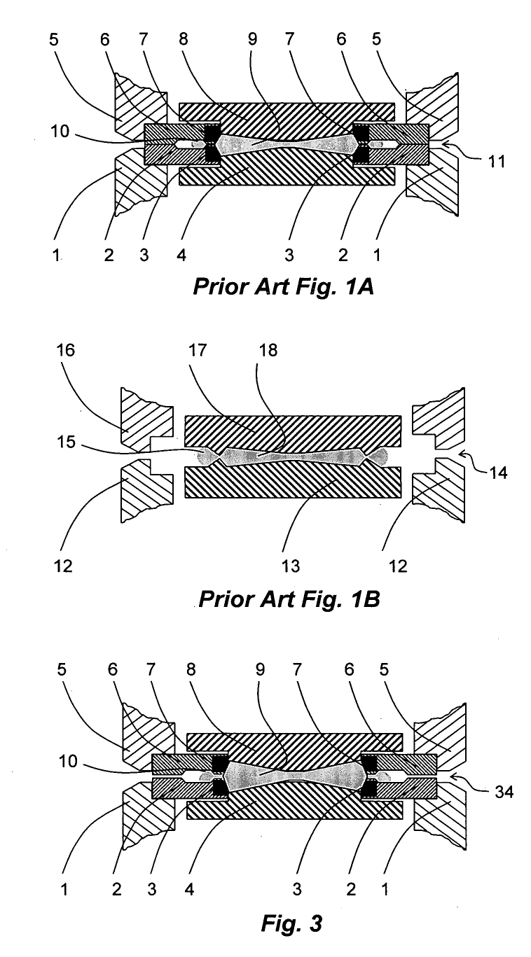

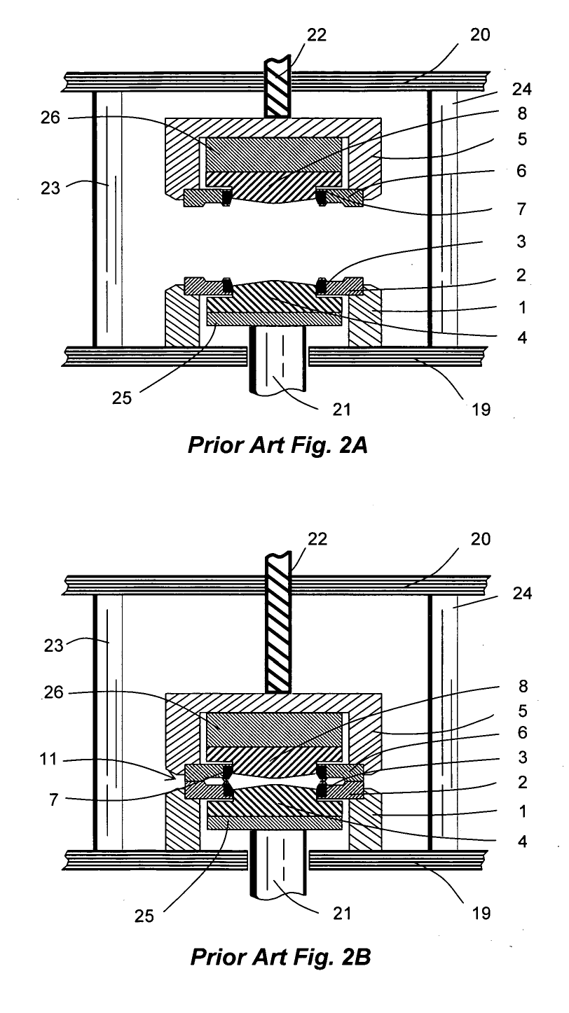

The present invention employs an standard sealed cavity system, an example of which is represented in FIG. 1A. In standard operation, the apparatus moves the cavity halves together by means such as a pneumatic cylinder, drive motor or other device. FIG. 2A illustrates a prior art apparatus with the cavity halves biased apart. FIG. 2B illustrates the cavity halves biased together forming the sealed cavity. The invention provides a method to prevent closure and thereby prevent complete sealing of the cavity. The standard sealed cavity system of the prior art (e.g. FIG. 1A) is adapted to operate as an unsealed system as shown in FIG. 3 by providing a cavity gap 34 between upper seal plate 6 and lower seal plate 2.

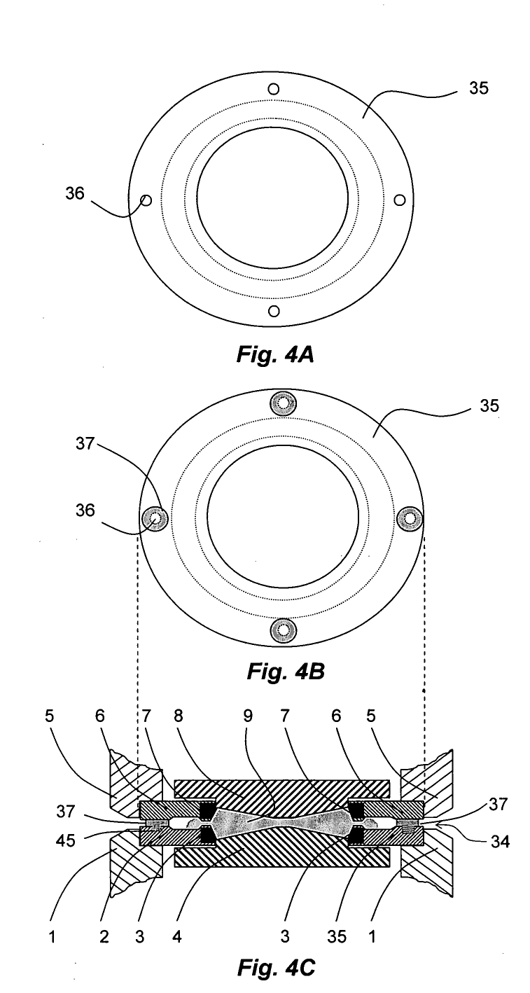

An embodiment of the invention is shown in FIGS. 4A-C. A novel seal plate 35 made in accordance with this invention is shown in FIG. 4A, having mounting holes 36. Seal plate 35 is substantially identical to and may replace either upper seal plate 6 or lower seal plate 2. The distinction in seal plate 35 being that it has mounting holes 36. The number of mounting holes may vary, but preferably at least two, and more preferably three, are employed, being equally spaced around the circumference of seal plate 35. In FIG. 4B, spacers 37 are shown mounted to holes 36. FIG. 4C illustrates two non-limiting examples of means by which spacers 37 may be affixed to mounting holes 36. In the hole 36 on the left side of FIG. 4C, spacer 37 is formed with a nipple 45 that may be forced into mounting hole 36 to frictionally hold spacer 37 therein. In the hole 36 on the right side of FIG. 4C, spacer 37 is shown as threaded to engage the threads provided in that hole. In the threaded spacer embodiment, the height to which the spacers extend could be established through the use of precision measuring guage, placed between the top surface of seal plate 35, and the underside of the head portion of the threaded spacer. In either embodiment, multiple spacers could be provided, with different sized spacers establishing different gaps. The spacers are preferably made of rigid material so as to accurately establish the correct gap.

Seal plate 35 may be mounted to either the upper or lower position in the cavity assembly, i.e., it may take a position to replace lower seal plate 2 or upper seal plate 6. The completed assembly is shown in FIG.4C, with seal plate 35 in the lower position. Spacers 37 create the cavity gap 34. Spacers 37 preferably extend above seal plate 35 to a height of from 0.02 to 2.0 mm, to provide a cavity gap 34 also ranging within those dimensions. These dimensions, however, are not intended to limit this invention.

Although spacers 37 are employed as separate elements that engage mounting holes in seal plate 35, it should be appreciated that seal plate 35, or, indeed, multiple seal plates, could be created having permanently machined spacers thereon, and such seal plates could be selectively chosen to be affixed to material testing apparatus in accordance with this invention to provide various cavity gap sizes. Spacers 37, with nipples 45, are preferred because, by providing spacers 37 of various heights, it will be easy to create a desired cavity gap.

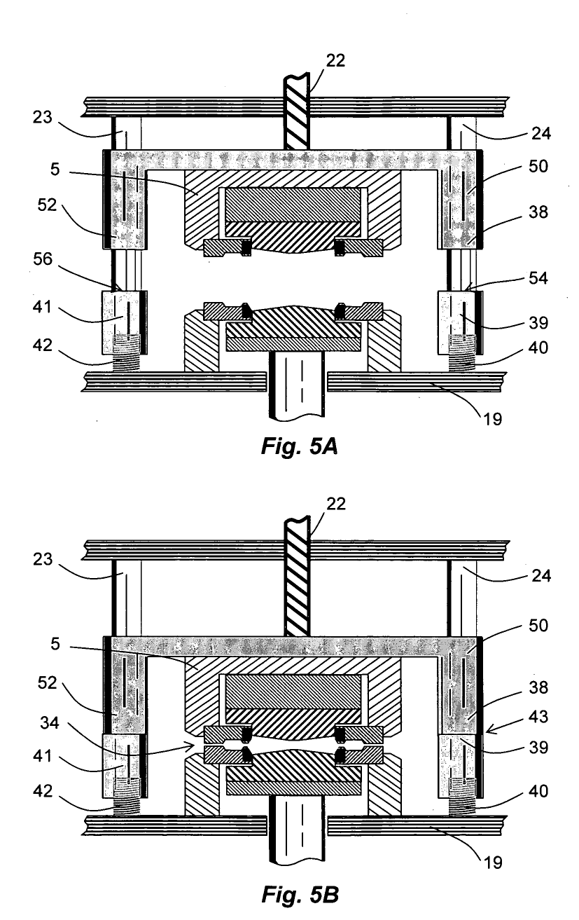

Another embodiment of the invention is shown in FIGS. 5A and 5B. Upper platen stop 38 is affixed to upper platen 5 and drive shaft 22. It provides guide sleeves 50, 52 that are secured about support rods 24 and 23, respectively. Threaded stop 39 is provided on support rod 24, and threaded stop 41 is provided on support rod 23. Threaded stops 39 and 41 respectively interact with threaded portions 40 and 42 of support rods 24 and 23, and the distance at which the top edges 54 and 56 of stops 39 and 41 reside above base platform 19 is adjustable due to this threaded engagement. This system is shown in the open position in FIG. 5A. When closed, as in FIG. 5B, upper platen stop 38, through guide sleeves 50 and 52, comes into contact with stops 39 and 41, as at contact 43, and creates the desired cavity gap 34. The cavity gap achieved is adjustable by adjusting threaded stops 39 and 41 on threaded portion 40 and 42 of support rods 24 and 23.

The embodiment of FIGS. 5A and 5B is shown as a preferred mode for practicing this invention, but this invention is not limited to or by such a specific embodiment. It should be appreciated that, rather than employing support rods, as shown, a separate guide rod having a threaded portion could be provided, with a sleeve of the platen stop secured around the guide rod and interacting with a threaded stop thereon. It is simply preferred to employ the support rods already existing in current material testing apparatus.

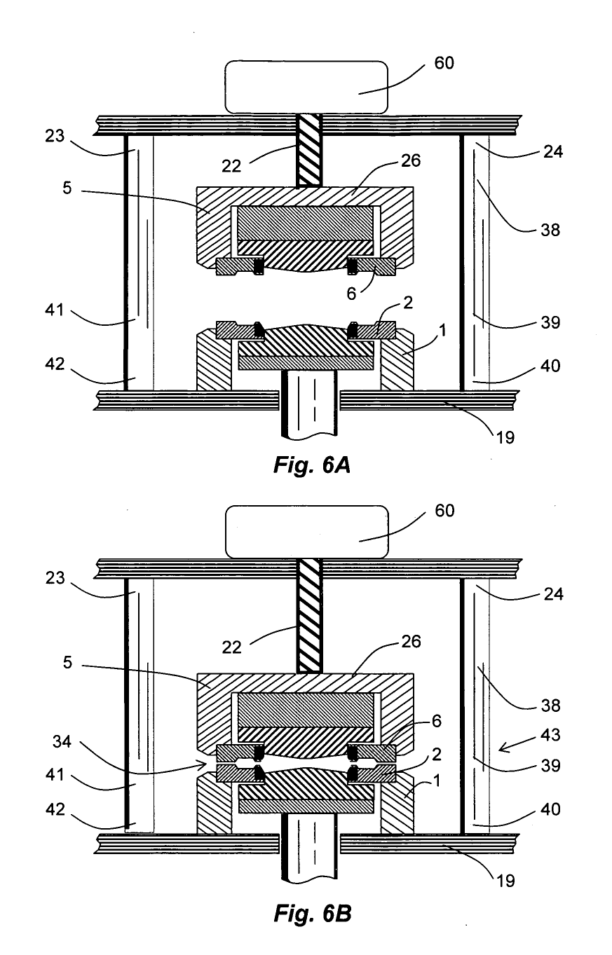

In FIGS. 6A and 6B, yet another embodiment for practicing this invention is shown and like parts to previous embodiments receive like numerals. In this embodiment, driver 60 advances upper platen 5, through drive shaft 22, toward lower platen 1 a select distance to provide a select gap distance between upper seal plate 6 and lower seal plate 2. In particularly preferred embodiments, driver 60 is a preselected distance driver, meaning that the distance that the driver is to drive upper platen 5, and, therefore, the size of the gap that is to be effected, can be preselected. For example, if the upper platen must move 20 centimeters to contact the lower platen, the driver could be programmed to permit an individual to select a gap size of 0.2 mm, and the driver would then move the upper platen 19.98 cm to achieve the desired gap. Such drivers are legion, and well known in the art. Thus, driver 60 may establish gap 34 through various means well known in the art. By way of non-limiting example, driver 60 may be a linear actuator (either driven by pneumatics, hydraulics or electric motors) employing adjustable stops. These stops may be mechanical, as with an adjustable stop pneumatic cylinder; travel limited, as in the case of a programmable stepper motor, or position limited as would be the case with an electric motor stop actuated by a positioning limit switch.

Thus, it can be seen that the present invention provides improvements in methods and apparatus for creating unsealed die cavities in a material testing apparatus. While, in accordance with the patent statutes, only the preferred embodiments of the present invention have been described in detail hereinabove, the present invention is not to be limited thereto or thereby. Rather, the scope of the invention shall include all modifications and variations that fall within the scope of the attached claims.

1. In a material testing apparatus including a first die associated with a first seal plate and a second die associated with a second seal plate, the first and second seal plates being in registration with each other and capable of movement toward and away from one another to contact a sample of material with both the first and second seal plates, the improvement comprising making the testing apparatus such that it can selectively be operated as either a sealed die system or an unsealed die system by providing:
a drive mechanism that is selectively activated to move the first seal plate toward or away from the second seal plate, thus moving the first die associated with the first seal plate toward the second die associated with the second seal plate; and
means for selectively stopping movement of the first seal plate toward the second seal plate such that the first and second dies contact the sample of material and the first and second seal plates are selectively caused to either (a) touch, thus creating a sealed die system or (b) not touch, with a gap between the first and second seal plates, thus creating an unsealed die system.

2. The improvement to a material testing apparatus as in claim 1, wherein said means for selectively stopping movement includes spacers selectively secured to one of said first or second seal plate.

3. The improvement to a material testing apparatus as in claim 1, wherein said means for selectively stopping movement includes a preselected distance driver.

4. The improvement to a material testing apparatus as in claim 1, wherein said apparatus further includes a guide rod and a first platen associated with said first seal plate, said first platen being moved by said drive mechanism to also move said first seal plate, and the means for selectively stopping movement includes:
a first platen stop associated with the first platen to move therewith when moved by said drive mechanism, said first platen stop having a sleeve secured about said guide rod; and
a stop on said guide rod that contacts said sleeve to limit the movement of said first platen stop.

5. The improvement to a material testing apparatus as in claim 5, wherein said stop is threaded and engages a threaded portion on said guide rod.

6. The improvement to a material testing apparatus as in claim 1, wherein said gap is from 0.2 mm to 2 mm.

7. A material testing apparatus comprising:
a first platen associated with a first die and supporting a first seal plate;
a second platen associated with a second die and supporting a second seal plate in registration with said first seal plate, wherein said first platen, said first die and said first seal plate may be selectively advanced, as a unit, toward said second platen, said second die and said second seal plate;
a spacer secured to one of said first and second seal plates such that, when said first seal plate is selectively advanced toward second seal plate, said spacer contacts between said first and second seal plates to prevent direct contact between said first and second seal plates.

8. The material testing apparatus of claim 7, wherein said spacer is secured to one of said first and second seal plates by a nipple that engages a hole in said one of said first and second seal plates.

9. The material testing apparatus of claim 7, wherein said spacer is secured to one of said first and second seal plates by threads that engage a threaded hole in said one of said first and second seal plates.
